(19) United States
(12) Patent Application Publication
(10) Pub. No.: US 2014/0306542 A1
(43) Pub. Date: Oct. 16, 2014

(54) Switch Disconnect Circuit for Solar Arrays

(71) Applicant: DRAKER, INC., Austin, TX (US)

(72) Inventor: Bertrand J. Williams, Austin, TX (US)

(73) Assignee: Draker, Inc., Austin, TX (US)

(21) Appl. No.: 13/860,639

(22) Filed: Apr. 11, 2013

(51) Int. Cl. H02J 1/00

(52) U.S. Cl. CPC H02J 1/00
USPC 307/80; 307/130

(57) ABSTRACT

A module for connecting (or coupling) and disconnecting (or decoupling) a photovoltaic panel (PV) to and from other PV panels in a string of PV panels. The module may include first circuitry for detecting when a voltage output by the PV panel (Vₚₐₙₑₗ) collapses, and second circuitry for disconnecting the PV panel from the panel string while preventing a transistor switching device (e.g. a power MOSFET) performing the disconnecting (decoupling) operation from entering the linear operating region. The combination of low-voltage detection in the first circuitry, and latching-switching in the second circuitry ensures that the power MOSFET is either fully turned on, coupling the PV panel to the panel string, or fully turned off, decoupling the PV panel from the panel string. The PV panel may be recoupled to the PV string through a connection-check mechanism that reengages the PV panel once Vₚₐₙₑₗ has returned to normal operating levels.

### BACKGROUND OF THE INVENTION

1. Field of the Invention

This invention relates generally to the field of photovoltaic arrays, and more particularly to disconnecting a photovoltaic panel from a bus that couples the photovoltaic panels in a photovoltaic array.

2. Description of the Related Art

Photovoltaic arrays (more commonly known and referred to as solar arrays) are a linked collection of solar panels, which typically consist of multiple interconnected solar cells. The modularity of solar panels facilitates the configuration of solar (panel) arrays to supply current to a wide variety of different loads. The solar cells convert solar energy into direct current electricity via the photovoltaic effect, in which electrons in the solar cells are transferred between different bands (i.e. from the valence to conduction bands) within the material of the solar cell upon exposure to radiation of sufficient energy, resulting in the buildup of a voltage between two electrodes. The power produced by a single solar panel is rarely sufficient to meet the most common power requirements (e.g. in a home or business setting), which is why the panels are linked together to form an array. Most solar arrays use an inverter to convert the DC power produced by the linked panels into alternating current that can be used to power lights, motors, and other loads.

The various solar array designs typically fall into one of two configurations, a low-voltage configuration when the required nominal voltage is not that high, and a high-voltage configuration when a high nominal voltage is required. The first configuration features arrays in which the solar panels are parallel-connected. The second configuration features solar panels first connected in series to obtain the desired high DC voltage, with the individual series-connected panel strings coupled in parallel to allow the system to produce more current. Various problems have been associated with both configurations, with the most prolific array configuration being the high-voltage series-string based configuration. The series-string configuration raises the overall distribution DC-bus voltage level to reduce resistive losses. However, in doing so it increases panel mismatch losses by virtue of the series-string being limited by the weakest panel in the string. In addition, the resultant DC-bus voltage has a significant temperature and load variance that makes inversion from DC to AC more difficult. There may also be instances when it becomes desirable to disconnect a panel from the series, whether due to faulty operation or other considerations. While sometimes a disconnect mechanism may be implemented in more costly control modules connected to each panel, there are many applications and systems where these costly control modules may not be required or might not be financially feasible, while an efficient and reliable disconnect mechanism might still be essential.

Many other problems and disadvantages of the prior art will become apparent to one skilled in the art after comparing such prior art with the present invention as described herein.

### SUMMARY OF THE INVENTION

Various embodiments of an interface circuit, or module for connecting and disconnecting a photovoltaic (PV) panel to and from a string of PV panels use a semiconductor-switched panel-level connect/disconnect, or engage/disengage mechanism, in which a single power MOSFET is used as the switching element to connect and disconnect, or engage and disengage the PV panel to and from the string. The interface circuit does not require but is fully compatible with any dynamic switching circuitry that may be included in an optimizer or DC/DC switching converter used in some PV array systems. The disconnect mechanism may use low voltage detection, triggering a switch disconnect to prevent the switching device (e.g. the power MOSFET) from ever entering and remaining in the linear operating region for more than a specified brief period of time, during which no considerable power is dissipated long enough to cause malfunction or damage to the circuitry.

The interface circuit may feature a latching arrangement paired with low-voltage detection to disconnect/disengage (or turn off) the power switching device (e.g. power MOSFET), and hold the switching device in the off position until a control signal from a microcontroller, timer or any suitable control circuit re-checks the connection to determine if conditions have improved, and the panel voltage, i.e. the output voltage provided by the PV panel has returned to a stable, usable value. The control of the switching state of the power switch may be programmable, and may be integrated with a remote command for disconnecting the switch. The switch disconnect may also be integrated within a mesh communications network connected to external sensors for additional detection functions, such as arc-fault, fire-detection, ground-fault, locally controlled red-button command shut-down, remotely commanded shut-down, etc. The interface circuit may therefore be automatically engaged to disconnect the PV panel when any one or more of a number of conditions make it desirable or necessary to do so.

A module for engaging and disengaging a PV panel situated in a string of PV panels may therefore include a first circuit to detect when a panel voltage provided by the PV panel drops below a specified level, and may further include a second circuit with a power switching device that controllably engages the PV panel to provide power to the string of PV panels and controllably disengages the PV panel to stop the PV panel from providing power to the string of PV panels. The second circuit may cause the power switching device to disengage the PV panel from the string of PV panels responsive to the first circuit detecting that the panel voltage has dropped below the specified level, and may prevent the power switching device from operating in a linear region for longer than a limited time duration regardless of a level of the panel voltage. In some embodiments, the second circuit may prevent the power switching device from operating in a linear region to prevent excess energy dissipation. For example, the power switching device may operate in the linear no longer than a specified time period that would result in at most a few hundred watt-seconds of energy being dissipated.

The first circuit may include a first comparator having a first input receiving a first control voltage derived from the panel voltage, and further having a second input receiving a first reference voltage. An output of the first comparator may indicate when the panel voltage drops below the specified level by changing states when a level of the first control voltage drops below a level of the first reference voltage. The second circuit may include a second comparator having a first input receiving a second control voltage derived from a voltage at the output of the first comparator, the second comparator also having a second input receiving a second reference voltage. An output of the second comparator may cause the power switching device to disengage the PV panel from the string of PV panels by changing states when a level of the second control voltage rises above a level of the second reference voltage. In one embodiment, the first comparator and the second comparator are powered by a supply voltage having a lower value than a minimum voltage required to turn on the power switching device. The second circuit may also include a divider circuit to sense a voltage across two channel terminals of the power switching device, where the second control voltage is further derived from the voltage sensed across the two channel terminals of the power switching device. The divider circuit may cause the power switching device to keep the PV panel disengaged from the string of PV panels by holding the level of the second control voltage above the level of the second reference voltage, responsive to the power switching device disengaging the PV panel from the string of PV panels.

In some embodiments, a circuit may be used for coupling and decoupling a PV panel to and from a bus connecting together a string of PV panels that includes the PV panel. The circuit may include a detection circuit to detect when a panel voltage provided by the PV panel drops below a specified level, and may also include a latching-switching circuit with a power switching device that may controllably establish, between the PV panel and the bus, a current path that includes the power switching device, and may also controllably disable that current path. The latching-switching circuit may operate to cause the power switching device to disable the current path responsive to the detection circuit detecting that the panel voltage has dropped below the specified level, and may prevent the power switching device from operating in a linear region for longer than a limited time duration regardless of a level of the panel voltage. The latching-switching circuit may prevent the power switching device from operating in the linear region by allowing the power switching device to remain turned on when the panel voltage is not below the specified level, and keeping the power switching device turned off when the panel voltage is below the specified level. In one embodiment, the power switching device is a power MOSFET.

The detection circuit may include a first device having an input to receive a first control voltage derived from the panel voltage, and further having an output that changes states when a level of the first control voltage drops below a first reference voltage level, indicative that the panel voltage has dropped below the specified level. The circuit may further include a first voltage divider circuit to generate the first control voltage by dividing down the panel voltage. In addition, the latching-switching circuit may also include a second device having an input to receive a second control voltage derived from a voltage developed at the output of the first device, and further having an output to turn off the power switching device by changing states responsive to a level of the second control voltage rising above a second reference voltage level. The first device and the second device may receive a supply voltage having a lower value than a minimum voltage required to turn on the power switching device.

In one embodiment, the latching-switching circuit also includes a divider circuit to sense a voltage across two channel terminals of the power switching device, with the second control voltage further derived from the voltage sensed across the two channel terminals of the power switching device. The divider circuit may be operated to cause the power switching device to prevent re-establishing the current path by holding the level of the second control voltage above the second reference voltage level responsive to the power switching device disabling the current path. The circuit may further include a transistor device having a built-in body-diode from a first channel terminal to a second channel terminal of the transistor device, with the first channel terminal coupled to the output of the first device and the second channel terminal coupled to the input of the second device, where a voltage at the output of the first device rising to a level commensurate with a supply voltage powering the first device and the second device causes the body diode of the transistor device to conduct, raising the second control voltage to a level approaching a specified value lower than the supply voltage.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 shows an example diagram of a conventional series-string and parallel branch solar array configuration;

FIG. 2a shows an example of a series-string solar array configuration retrofitted with interface modules (which may include DC/DC converters and/or circuitry to engage/disengage a PV panel from the string) attached to the solar panels;

FIG. 2b shows an example of a parallel-string (parallel connected) solar array configuration with interface modules attached to the solar panels;

FIG. 3 shows an example V/I power curve for a series-string solar array configuration;

FIG. 4 shows one embodiment of an interface circuit for connecting and disconnecting a photovoltaic panel to and from a string of photovoltaic panels;

FIG. 5 shows another embodiment of an interface circuit for connecting and disconnecting a photovoltaic panel to and from a string of photovoltaic panels, in which the power switching device never enters the linear operating range;

FIG. 6 shows current and voltage diagrams partially illustrating operation of the embodiment of the interface circuit of FIG. 4;

FIG. 7 shows current and voltage diagrams illustrating operation of the embodiment of the interface circuit of FIG. 5, when the panel voltage drops below the panel trip voltage, then returns to normal;

FIG. 8 shows current and voltage diagrams partially illustrating operation of the embodiment of the interface circuit of FIG. 5, when a connection attempt is made when the panel voltage drops to a voltage level near the threshold voltage of the power switch;

FIG. 9 shows current and voltage diagrams partially illustrating operation of the embodiment of the interface circuit of FIG. 5 when a connection attempt is made when the panel voltage drops but stays above the panel trip voltage; and

FIG. 10 shows a flowchart of a method for coupling and decoupling a PV panel of a string of PV panels to and from a bus that connects together the string of PV panels.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).” The term “include”, and derivations thereof, mean “including, but not limited to”. The term “connected” means “directly or indirectly connected”, and the term “coupled” means “directly or indirectly connected”.

### DETAILED DESCRIPTION OF THE PREFERRED EMBODIMENTS

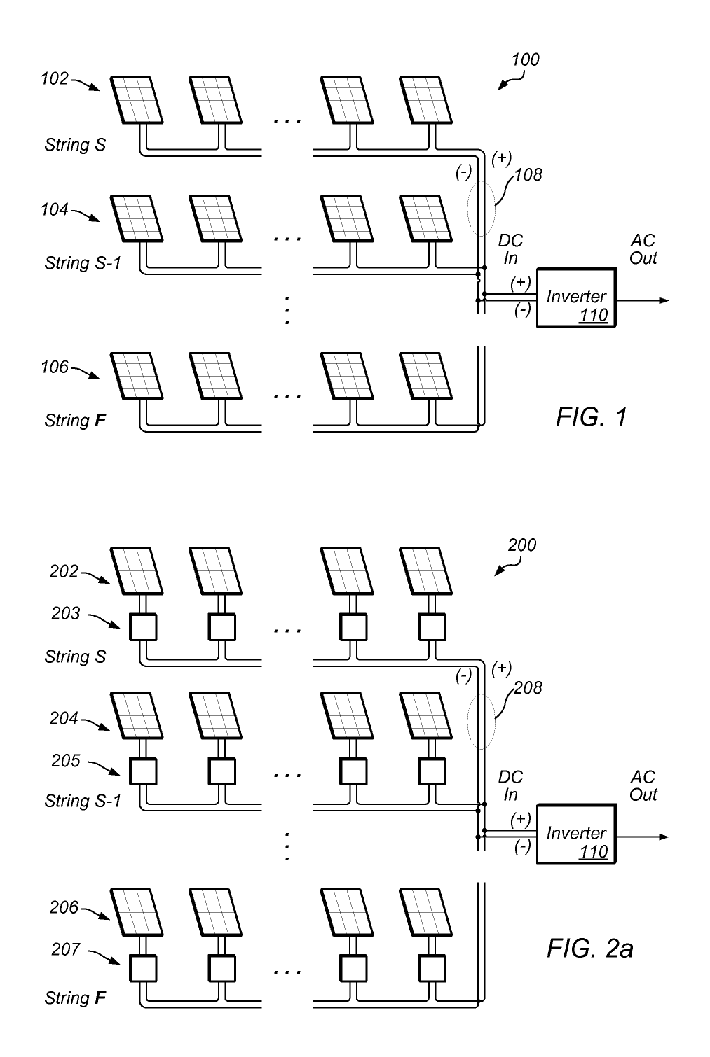

In solar array systems, many non-idealities may be mitigated by utilizing distributed Maximum Power Point Tracking (MPPT). Distributed MPPT usually includes insertion of a DC/DC converter or a similar power converter behind solar panels in the array, most commonly behind each and every solar panel in the array, to adapt the coupled solar panel's power transfer onto a high-voltage bus (typically a high-voltage DC bus) which connects the panels together via the DC/DC converters. A typical solar array 100 is shown in FIG. 1. Solar panel series-strings 102, 104, and 106 are coupled in parallel to bus 108, which may be a DC/DC bus. Each solar panel series-string includes solar panels coupled in series to a respective bus, each of those respective buses coupling to bus 108 as shown to obtain parallel-coupled solar panel series-strings. An inverter 110 is coupled to bus 108 to ultimately drive a connected load, which may be coupled to the output of inverter 110.

An example of the V/I (voltage/current) characteristic for each solar panel is shown in FIG. 3. As seen in FIG. 3, the V/I characteristic may be modeled as a current source in parallel with a multiplied shunt diode, where the current is proportional to the solar insolation levels, and the shunt diode is the result of the solar cell diode in each cell multiplied by the number of cells in series which make up that solar panel. Curve 302 represents the V/I curve, that is, the current I output by the solar panel (represented on the vertical axis) for a given output voltage V (represented on the horizontal axis), under normal operating conditions. Curve 304 represents the power curve associated with V/I curve 302, showing the maximum power point P_{MP}, that is, the point at which the product of the current and voltage output by the solar panel is at its maximum. These values are indicated as I_{MP} and V_{MP}, respectively, and I_{MP}*V_{MP}=P_{MP}. V_{OC} indicates the open circuit voltage output by the solar panel, that is, the voltage output by the solar panel when not providing current to a load. Similarly, I_{SC} indicates the short circuit current output by the solar panel, that is, the current output by the solar panel with its output terminals shorted together. V_{BUS} indicates the total voltage that appears on the bus for N solar panels connected in the series-string. Curve 303 represents the V/I curve, (again, the current I output by the solar panel for a given output voltage V) when the panel is impaired in some way. For example, the panel may be shaded, thus not receiving as much sunlight as expected. As indicated by curve 303, the changed V/I characteristic might adversely affect the V_{BUS}, and may thus also affect operation of the other panels in the string.

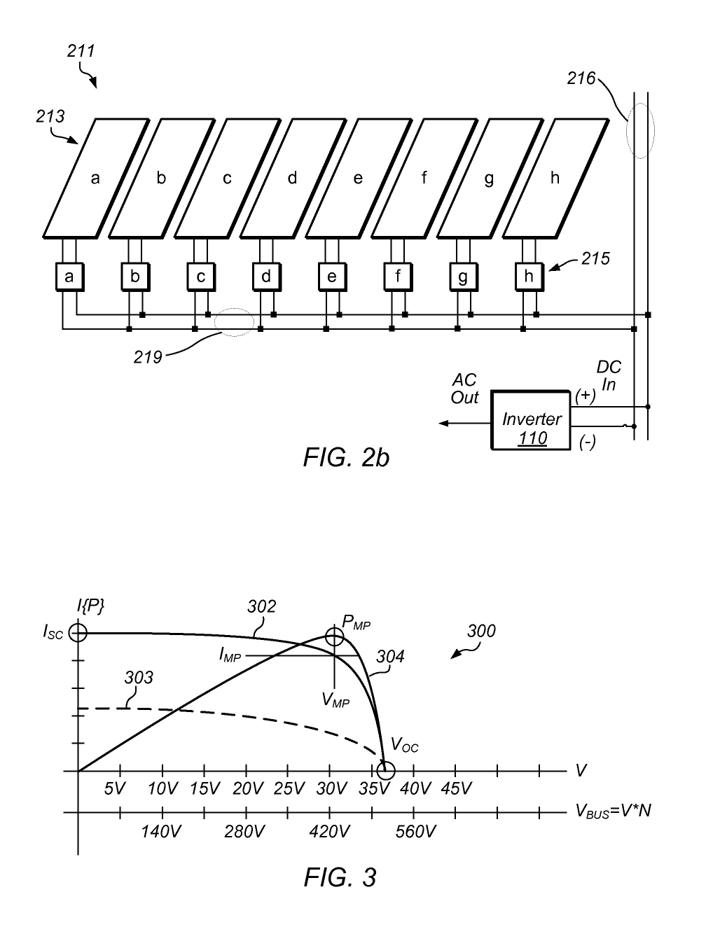

FIG. 2a shows one embodiment of a system 200 featuring solar panel series-strings 202, 204, and 206, with each of solar panels 202, 204, and 206 coupled to a respective interface module of interface modules 203, 205, and 207, respectively. The interface module may be a power converter unit, which may include a control unit and a power converter controlled by the control unit, and providing a voltage for the respective bus to which the given string is coupled, with the buses coupling to bus 208 in parallel as shown. Thus, respective outputs of the power converters and controllers 203 are series coupled to high voltage DC bus for String S, the respective outputs of the power converters and controllers 205 are series coupled to high voltage DC bus for String S-1, and the respective outputs of the power converters and controllers 207 are series coupled to high voltage DC bus for String F, with the three buses parallel coupled to high voltage DC bus 208. Inverter 110 may be coupled to bus 208 in system 200, to drive a connected load(s). For the sake of clarity, each power converter and controller will be referred to herein simply as a “converter unit”, with the understanding that each converter unit may include a power converter, e.g. a DC/DC switching converter, and all associated control circuitry/unit, e.g. functional units to perform MPPT. Each of the attached converter units 204 may be designed to execute a control algorithm, which may exercise control over a switching power conversion stage.

In alternate embodiments, the respective outputs of the power converters and controllers 204 may be parallel coupled to high voltage DC bus 208, which may be coupled to high voltage DC bus 206. FIG. 2b shows one embodiment of a system 211 featuring a solar panel parallel-string 213, in which each of solar panels 213a-h is coupled to a respective converter unit 215a-h. Converter units 215a-h may also each include a control unit and a power converter providing a voltage for bus 219, and controlled by the control unit. For example, panel 213a is coupled to converter unit 215a, panel 213b is coupled to converter unit 215b, and so on. The respective outputs of the power converters and controllers 215 are then parallel coupled to high voltage DC bus 219, which may be coupled to high voltage DC bus 216. Each of the attached converter units 215 may be designed to execute a control algorithm, which may exercise control over a switching power conversion stage.

As previously mentioned, there may be cases where some or all panels in an array, for example in system 200, may not be coupled to a power controller unit, or the solar array may be constructed as system 100 shown in FIG. 1, but there is still a need for a disconnect mechanism for individual panels. One possible solution in such a case may to establish a switching mechanism that may be operated to disengage (or decouple) the panel from the string when necessary, for example to mitigate panel impairment. The switching mechanism may be implemented in an interface module, e.g. an interface module such as modules 203, 205, 207, even when interface modules do not include power controller units, possibly because the system doesn't require power controller units. In some embodiments, interface modules 203, 205, 207 may include power controller units only, a switching mechanism only, or a combination as desired. Thus, there may be embodiments in which interface modules 203, 205, 207 do not include power controller functionality, only the switching functionality to couple/decouple (or engaged/disengage) the corresponding PV panel to/from the string. The interface module may thus include a switching device or semiconductor device, for example a field effect transistor (FET) configured in a disconnect circuit as a power switch to act as a connect/disconnect between the solar PV modules (e.g. individual panels in 102-106 shown in FIG. 1, or individual panels in 202-206 shown in FIG. 2a), and the attached series string of modules (102-106 shown in FIG. 1, or 202-206 shown in FIG. 2a, respectively).

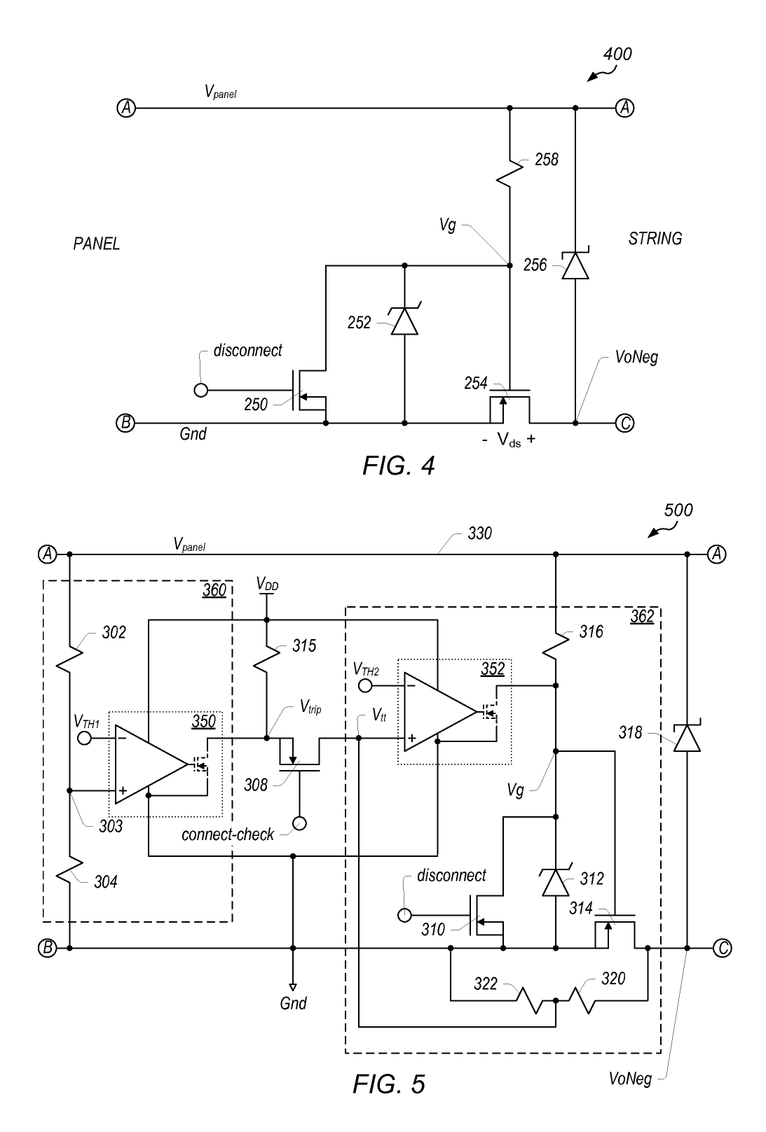

As mentioned above, one solution to providing a connect/disconnect mechanism is to place an interface module at the output of the PV panel, and operate the interface module to connect and disconnect the PV panel. One embodiment of a simple interface circuit that may operate to connect and disconnect the PV panel from the string is shown in FIG. 4. In the embodiment (circuit 400) of FIG. 4, a power NMOS FET 254 is coupled in the ground (GND) return leg of the PV (solar) module/panel. Terminal ‘A’ represents the positive terminal of the output port of the PV panel, which is connected to the positive input terminal of the input port of circuit 400. Similarly, terminal ‘B’ represents the negative terminal of the output port or ground return leg of the PV panel, and is connected to the negative terminal of the input port of circuit 400. The output port of circuit 400 may couple to the string. As shown in FIG. 4, the negative terminal ‘B’ of the PV module (and consequently the negative input terminal of circuit 400) is connected to GND, with the source terminal of NMOS FET 254 also coupled to GND, and the drain terminal of NMOS FET 254 connected to the negative terminal ‘C’ of the output port of circuit 400. The positive terminal of the output port of circuit 400 is connected as an electrical continuous pass through to the positive terminal ‘A’ of the input port of circuit 400 (and consequently to the positive terminal of the output port of the PV panel), and is therefore also labeled as terminal ‘A’. In this configuration, a Schottky Diode 256 is coupled across the output port of circuit 400 between terminals ‘A’ and ‘C’ for protection, to handle potential string currents during switching off conditions.

In order to switch (or turn) on an NMOS power FET such as power MOSFET 254, a gate voltage of specified value, typically greater than 5V, is applied to the gate. In most practical applications this voltage may be typically greater than 7V, preferably 10V, in order to achieve good MOSFET channel conductivity and minimal ‘on’ resistance. The gate threshold for a medium- to high-voltage NMOS power FET is typically in the 3V to 4V range, and thus the device begins to conduct heavily in this range. In circuit 400, the gate voltage for power MOSFET 254 is expected to be supplied by the attached PV module (as the panel voltage Vₚₐₙₑₗ generated by the PV panel), and since a PV module/panel normally operates at an optimal voltage of ˜20-50 volts, this does not present a problem under normal operating conditions. Therefore, a simple resistive connection (through resistance 258) to the positive terminal ‘A’, with a Zener clamp 252 coupled as shown, and clamping at a designated value, e.g. at ˜10V, is sufficient to supply the gate connection to power MOSFET 254. A simple low voltage FET 250 may then be used to pull-down this resistive gate terminal to shut off FET 254, when a ‘disconnect’ signal is asserted to the gate of FET 250.

Circuit 400 may operate well under certain conditions, and when power MOSFET 254 is turned on, circuit 400 may operate to connect the PV module/panel to the string. Conversely, circuit 400 may operate to disconnect the PV module/panel from the string, by opening the circuit connection between terminals ‘B’ and ‘C’ by turning off MOSFET 254. However, since power MOSFET 254 is a nonlinear analog device, albeit with a reasonably high gain, and not a truly digital switch (i.e. not an ideal switch), there are cases in which operation of circuit 400 may lead to a failure of the system (e.g. a failure of a system such as system 100 shown in FIG. 1 and/or system 200 shown in FIG. 2a).

One example of a system failure while using interface circuit 400 as a disconnect circuit will now be considered. During normal operation, when power MOSFET 254 is turned on, the attached PV panel is connected to the string. However, if the attached PV module/panel becomes sufficiently weak compared to others in the string (for example when it is overshadowed and thus fails to receive the expected amount of light), the voltage (Vₚₐₙₑₗ) of the PV module may collapse as the PV panel attempts to supply the string current. To put it another way, due to impairment, such as the absence of sufficient light energy received by the PV panel, the capability of the attached PV module is reduced, and in an attempt to still provide the expected energy in form of the expected panel current, the panel voltage of the PV panel may collapse. In such a case, the panel voltage Vₚₐₙₑₗ provided by the attached PV module/panel may collapse toward zero volts. In some cases, Vₚₐₙₑₗ may actually drop all the way down to zero volts (0V).

As the value of Vₚₐₙₑₗ crosses through the FET threshold voltage, (the voltage needed to turn on MOSFET 254, e.g. ˜4V) while the voltage Vₚₐₙₑₗ is decreasing, power MOSFET 254 turns off, which disconnects the PV module/panel from the string. Once power MOSFET 254 has been disconnected, current can no longer flow from the attached PV module/panel, and thus the voltage Vₚₐₙₑₗ begins to increase, which again turns power MOSFET 254 back on. This produces negative feedback behavior, causing circuit 400 to operate as a negative feedback system, which either oscillates around the MOSFET threshold voltage (e.g. ˜4V), or stabilizes at a fixed voltage value commensurate with that threshold voltage. When the gate voltage (Vg) of MOSFET device 254 stabilizes at around the threshold voltage (˜4V), the drain-source voltage (Vds, or Vd) also stabilizes at a voltage value that is within the range of the threshold voltage, resulting in power MOSFET 254 beginning to operate in the linear region, and not being fully switched on. In this state (i.e. when operating in the linear region), the power dissipated in power MOSFET 254 is ‘V*I’, i.e. ‘Vds*Ids’, with Ids representing the drain-source current. For example, if the value of Ids is 6 A, and Vds has a value of 4V, power MOSFET 254 may be dissipating 24 Watts. Such power dissipation may be sufficient to cause overheating in circuit 400 to the point of various components and/or solder traces within the device/circuit 400 melting down.

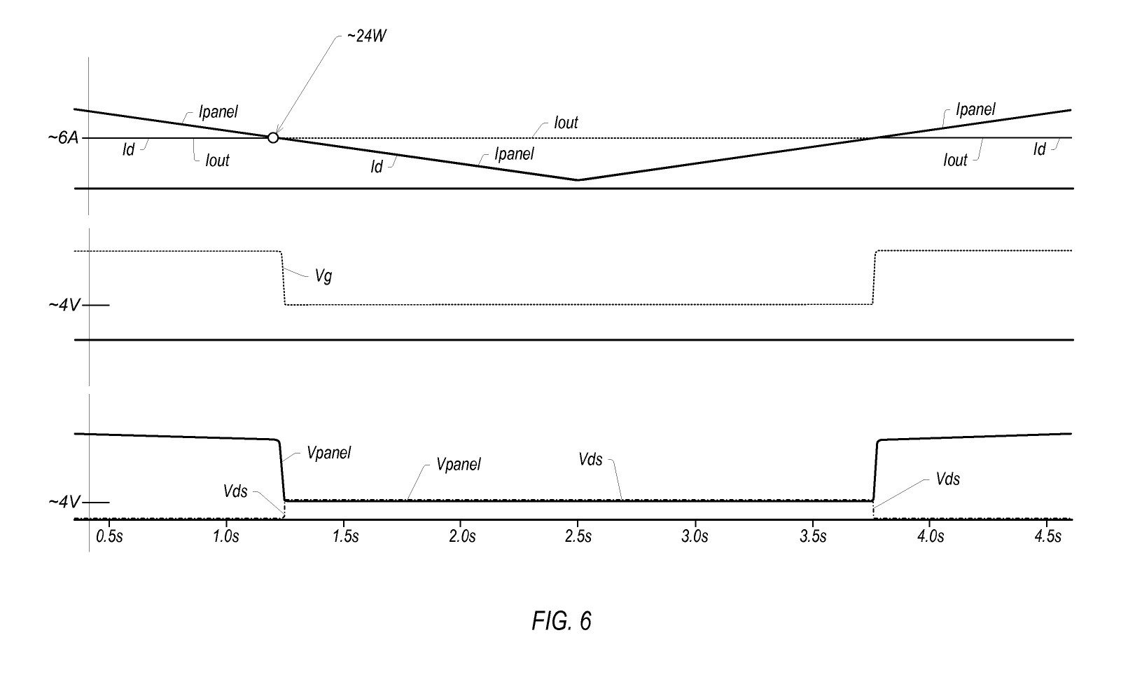

This behavior is illustrated in the signal diagrams of FIG. 6, highlighting the behavior, among others, of the panel current (Ipanel), output current (lout), and the drain current (Id) of power MOSFET 254. Specific values for voltage, current, and power are shown for illustrative purposes according to one specific embodiment. FIG. 6 also shows voltage waveforms for the gate voltage (Vg) of power MOSFET 254, the panel voltage (Vₚₐₙₑₗ), and the voltage (VoNeg) at negative output terminal ‘C’ (it should be noted here that by virtue of the source of MOSFET 314 being coupled to a voltage reference, i.e. ground in this case, VoNeg is also representative of Vds across MOSFET 314). These voltages are also respectively labeled in FIG. 4 and FIG. 5 at their corresponding nodes. As illustrated in FIG. 6, as the impaired panel is no longer capable of keeping the Ipanel current at or above the level of lout, i.e. as Ipanel falls below lout, Vₚₐₙₑₗ begins to collapse to a level commensurate with the threshold voltage of power MOSFET 254, which in this example is shown to be ˜4V. Consequently, voltage Vds rises to the same level (i.e. to the threshold voltage of power MOSFET 254, e.g. ˜4V). The gate voltage Vg of power MOSFET 254 also tracks the panel voltage Vₚₐₙₑₗ. The current Id in MOSFET 254 also tracks the available Ipanel current, while the remainder of the current passes through Schottky diode 256, which is illustrated in FIG. 6 by the difference between the output current lout and the power MOSFET current Id. During the period (shown as the time span between ˜1.25 sec and ˜3.75 sec), power MOSFET 254 is operating in the linear region. Thus, while circuit 400 can operate to disconnect the PV panel from a string by using a simple power transistor device, it may become unreliable under certain conditions, and may cause malfunction when power MOSFET 254 operates in the linear region as described above.

FIG. 5 shows one embodiment of an interface circuit 500 which may be used to disconnect/connect a PV panel from/to the string, while eliminating the hazards associated with circuit 400. As shown in FIG. 5, in circuit 500 the voltage Vₚₐₙₑₗ is divided down with a first resistive voltage divider circuit that includes resistances 302 and 304. Thus, when Vₚₐₙₑₗ drops below a specified voltage value, referred to herein as the ‘panel trip voltage’, the divided voltage at node 303 connected to the non-inverting input of comparator 350 drops below the threshold value V_{TH1} of comparator 350, causing comparator 350 to trip. In some embodiments, V_{TH1} may be specified such that when Vₚₐₙₑₗ drops to a value of about 12.5V, the voltage at node 303 drops just below V_{TH1}, and trips comparator 350. It should be noted that while the embodiment shown in FIG. 5 features comparators 350 and 352, optionally configured with an Open-Drain/Collector configuration as shown in FIG. 5, in alternate embodiments the comparators may be replaced with FETs or bipolar transistors configured to operate in a manner similar to the operation of comparators 350 and 352. This operation will be described in further detail below.

As seen in FIG. 5, the output of comparator 350 is coupled to Vdd through resistor 315, while the output of comparator 352 is coupled to Vₚₐₙₑₗ through resistor 316. When the voltage Vₚₐₙₑₗ is greater than the specified panel trip voltage value at which the divided down voltage at node 303 falls below V_{TH1}, the voltage at node 303 is above the threshold voltage V_{TH1}, and the output voltage Vtrip at the output of comparator 350 is low. FET 308 may feature a built in body-diode from its source to its drain, and when voltage Vtrip is low, the body-diode in FET 308 may be reverse biased by setting the value of the signal ‘connect-check’ to low, i.e., by deasserting the connect-check signal. In some embodiments, a low value for the ‘connect-check’ signal may be designated as the default state of the ‘connect-check’ signal during normal operation.

The node where voltage Vtt is developed is connected across the drain-source terminals of MOSFET 314 (or looking at it another way, across terminals ‘C’ & ‘B’, respectively, or looking at it yet another way, between voltage values Vds and GND, respectively) via a second resistive voltage divider that includes resistors 320 and 322.

The second voltage divider circuit effectively forms a drain voltage sense circuit at node Vtt. If Vtrip is low, and transistor device 308 is turned off with its body-diode reverse biased, the voltage at terminal ‘C’ (Vds) operates to set the voltage value of Vtt via the second divider circuit alone. In other words, if Vtrip is low, the value of voltage Vtt is determined by the second voltage divider circuit, based on the value of Vds. If the main power MOSFET 314 is turned off and disconnected, Vds resides at a positive voltage level, setting Vtt to a corresponding voltage level determined by the second voltage divider. On the other hand, if MOSFET 314 is turned on, there is a near-zero voltage drop across the drain and source terminals of MOSFET 314 (i.e. between terminals ‘B’ and ‘C’), resulting in Vtt residing at a near-zero or zero voltage level.

In the above case, when Vtt is equal to zero, the voltage Vₚₐₙₑₗ supplies current into the clamped comparator 352, which has its open-drain/collector configured output coupled to Vₚₐₙₑₗ through resistor 316, as previously indicated. In this state, the clamped voltage at the output of comparator 352 is set by zener diode 312, providing a gate voltage (Vg) level high enough to turn on power MOSFET 314. In one set of embodiments, for a 4.5V threshold voltage for MOSFET 314, circuit 500 may be designed to obtain a Vg of approximately 10V for the scenario described above. Comparator 352 may be designed to have a threshold voltage V_{TH2} of ˜1.5V for this example. Thus, in the state described above, power MOSFET 314 is turned on, and power is provided by the attached PV module/panel to the output ports (at terminals ‘A’ and ‘C’) of circuit 500.

However, when Vₚₐₙₑₗ drops to a value (e.g. below ˜12.5V) such that the voltage at the positive input terminal of comparator 350 (node 303) falls below V_{TH1}, comparator 350 trips, and the node voltage Vtrip rises to Vdd (which may be specified to have a value of 3.3V in some embodiments). Vtrip rising to Vdd causes the body-diode of transistor device 308 to conduct, raising the node voltage Vtt to a level approaching a value slightly under Vdd, which results in node voltage Vtt exceeding the threshold voltage V_{TH2} of comparator 352 (where V_{TH2} is specified to be lower than Vdd). For example, if V_{TH2} is specified to be ˜1.5V, Vtt exceeds V_{TH2} as it crosses ˜1.5V. This causes the voltage at the output comparator 352 to fall to GND, thereby pulling Vg to GND, which turns off power MOSFET 314.

When MOSFET 314 turns off, Vds (which may be connected to an active string) rises to a sufficiently high voltage to hold node Vtt at a level above the comparator 352 threshold voltage of V_{TH2}. The values of resistors 320 and 322 in the second voltage divider circuit may be specified such that this latching effect occurs at voltages greater than a certain specified value of voltage Vds at node ‘C’. More specifically, this specified voltage value for Vds may correspond to a value marginally less than the panel trip voltage associated with Vₚₐₙₑₗ as previously described. To put it another way, the values of resistors 320 and 322 in the second voltage divider circuit may be specified such that the latching effect occurs at a voltage somewhat less than the value of Vₚₐₙₑₗ that causes the voltage at node 303 to fall below V_{TH1}. For example, if the panel trip voltage associated with Vₚₐₙₑₗ is i around 12.5V, the specified voltage value for Vds at which the latching occurs may be 10V, and the values of resistors 320 and 322 may therefore be specified to have the latching occur at values of Vds around 10V. Once the latching is in effect, power MOSFET 314 remains turned off, and circuit 500 operates to keep the PV panel disengaged from the string.

To turn power MOSFET 314 back on, that is, to attempt to reconnect the PV panel to the string, the ‘connect-check’ signal applied to the gate of FET 308 may be asserted. If the state of the comparator 350 indicates that the value of Vₚₐₙₑₗ is i greater than the panel trip voltage, that is, the voltage at node 303 is greater than V_{TH1}, and thus Vtrip is low, then Vtt is pulled low when transistor device 308 is conducting, and the latching effect is eliminated. This results in the output of comparator 352 switching from a low to a high output value, raising gate voltage Vg, and turning on power MOSFET 314, and holding it in the ‘on’ state. The latching voltage detect at Vₚₐₙₑₗ may be designed to guarantee that sufficient gate-drive is always available to maintain the power MOSFET 314 in a fully ‘on’ state, thereby preventing power MOSFET 314 from operating in the linear operating region for any extended period of time. More specifically, any time MOSFET 314 begins operating in the linear operating region, it may be controlled to exit the linear operating region within a specific period of time, where the specific period of time corresponds to a specified (upper bound) level of energy dissipated by the system. That is, MOSFET 314 may be controlled to never operate in the linear operating region long enough for the energy dissipated by the system to rise over a specified energy level. To put it yet another way, MOSFET 314 may be controlled to exit the linear operating region (should it have entered the linear operating region for any reason) before the energy dissipated by the system rises over a specified level. In one set of embodiments, this energy level may be specified as at most a few hundred Watt-Seconds (Joules).

To controllably flip the state of POWER FET 314 to a “disconnected” state even when Vₚₐₙₑₗ is i at a normal operating value, it is sufficient to pull-down the gate voltage Vg to a sufficiently low value (below the threshold voltage V_{TH} of power MOSFET 314) to turn off power MOSFET 314, and the latching comparator 352 will re-latch in the ‘off’ state due to the rise in voltage at node VoNeg coupled with the effect of the second voltage divider circuit, as previously described. If the control wiring on the ‘disconnect’ signal applied to the gate of transistor device 310 is pulled high to Vdd (e.g. 3.3V), and the ‘connect-check signal’ applied to the gate of transistor device 308 is pulled low, then the circuit enters a ‘disconnected’, or ‘disengaged’ operating state. That is, under normal operating conditions, if the ‘disconnect’ signal is pulled high (which may be considered the asserted state) and the ‘connect-check’ signal is pulled low (which may be considered the deasserted state), the PV panel/module is disengaged from the PV string. Conversely, when the ‘disconnect’ signal is pulled low, and a positive pulse is applied at the connect-check node, power MOSFET 314 is turned on, relaying (or coupling) the power from the attached PV module to the string. It should be noted that the preferred default values for the ‘disconnect’ signal and the ‘connect-check’ signal may be specified as desired, based on what the desired normal (default) operating mode of circuit 500 is. For example, in some embodiments, the ‘disconnect’ signal may be pulled low as the default value, and the ‘connect-check’ signal may be pulled high as the default value, for a reverse version of the behavior described above.

As shown above, various embodiments of an interface circuit (or module) for connecting and disconnecting, or engaging and disengaging a PV panel in a series-connected string of PV panels may include a mechanism using a single power MOSFET as the main switching element that connects (couples) and disconnects (decouples) the PV panel to and from the string of PV panels. The switching element may be controllably operated to engage the PV panel to have the PV panel provide power to the PV string, and disengage the PV panel to prevent the PV panel from providing power to the PV string. In this sense, engaging the PV panel means that the PV panel becomes an operational panel within the string of PV panels and contributes power to the string, while disengaging the PV panel effectively makes the PV string operate without the disengaged PV panel, which doesn't provide any power to the string. The interface circuit doesn't require dynamic switching circuitry, but it is fully compatible with any dynamic switching circuitry that may be present in optimizers or DC/DC switching converters, e.g. converters 203, 205, 207 shown in FIG. 2a. In addition, various embodiments of the disconnect (or decouple, or disengage) mechanism described herein use low-voltage detection, triggering a switch disconnect to prevent the power switching device (power MOSFET) from ever entering and operating in the linear operating region for any extended period of time, or for more than a very brief period of time.

The interface circuit(s) or module(s) may feature a latching arrangement (circuitry 362 in FIG. 5) paired with low voltage detection (circuitry 360 in FIG. 5) to disconnect (turn off) the power switching device (314), and hold the power switching device in the off position until a control signal (from a microcontroller, microprocessor, timer or any suitable control circuit) re-checks the connection to ascertain if conditions have improved, and the panel voltage (Vₚₐₙₑₗ) has returned to a proper operating value. Control of the switching state of the power switching device may be programmable, and may be integrated with a remote command receipt for disconnecting the power switch. Finally, the switch disconnect may be integrated within a mesh network connected to external sensors for additional detection functions, such as arc-fault, fire-detection, ground-fault, etc., as well as locally controlled red-button command shut-down, and remotely commanded shut-down. The interface circuit may therefore be automatically engaged to disconnect the PV panel from the string when any one or more of a number of conditions warranting a disconnection are met.

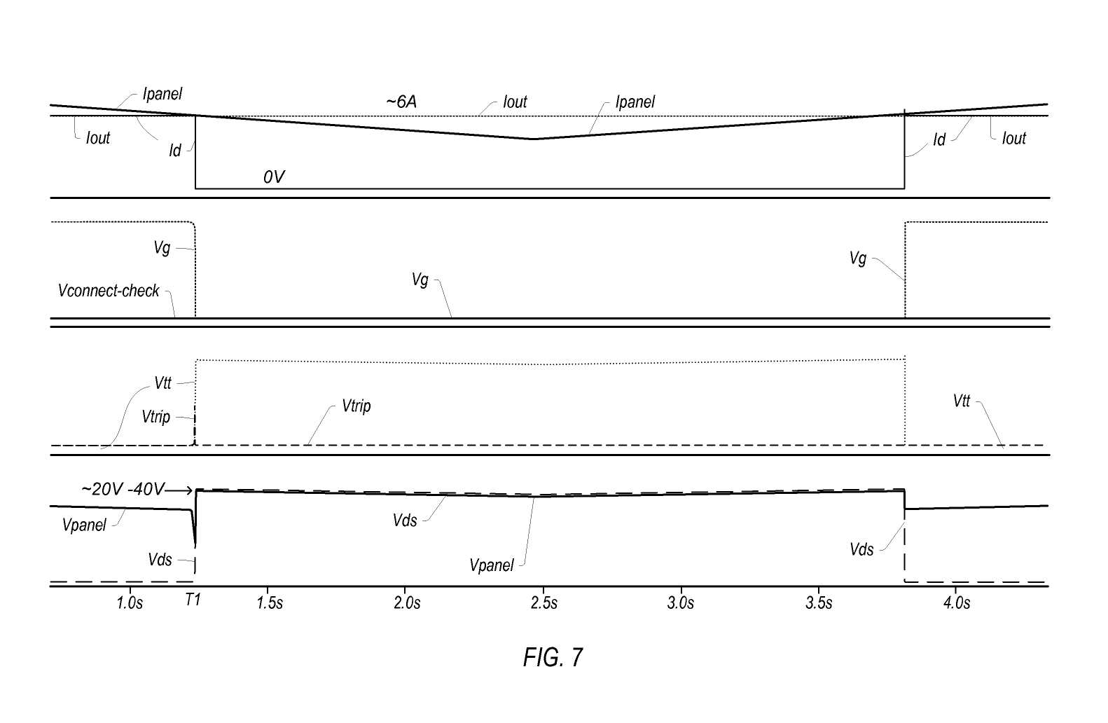

FIG. 7 shows current and voltage diagrams illustrating operation of circuit 500, when the panel voltage drops below the panel trip voltage, then returns to normal. As seen in FIG. 7, at time point T1 the panel voltage Vₚₐₙₑₗ drops below the panel trip voltage as the value of panel current Ipanel falls below the value of output current lout, resulting from the PV panel's inability to provide the appropriate expected current. Responsive to the value of Vₚₐₙₑₗ dropping below the panel trip voltage value, Vtrip rises, which causes the value of Vtt to also rise. This trips comparator 352, which results in Vg dropping to a low value, shutting of the power switch (power MOSFET 314 in FIG. 5). Responsive to the power switch being shut off, Vds rises, creating the latching effect by keeping Vtt at a high level, even after Vₚₐₙₑₗ returns to a normal operating value, as Vconnect-check is kept low. Vtrip returns to a low value, responsive to Vₚₐₙₑₗ returning to the normal operating value.

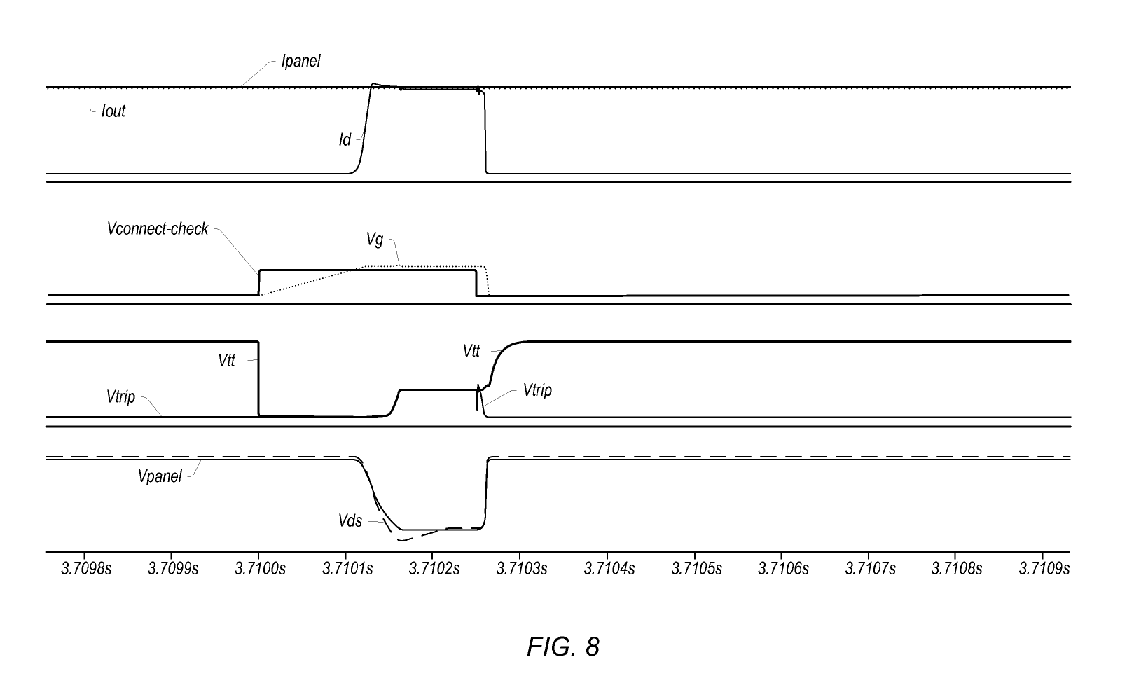

FIG. 8 shows current and voltage diagrams partially illustrating operation of circuit 500, when a connection attempt is made when the panel voltage drops to a voltage level near the threshold voltage of the power switching device. As seen in FIG. 8, before the 3.71 sec mark, Vₚₐₙₑₗ is at a normal operating level. Accordingly, at this point, Vtrip is low, that is, the output of comparator 350 is low. When Vconnect-check (to the gate of FET 308) is asserted (pulsed), and thus raised to a high level, FET 308 begins conducting, pulling Vtt low, which leads to Vg (output of comparator 352) rising to a level commensurate with Vₚₐₙₑₗ. However, just as Vg reaches the level of Vₚₐₙₑₗ, Vₚₐₙₑₗ drops to a voltage level lower than but near the threshold voltage of the power switching device, e.g. ˜4V, also causing Vds to drop to the same level. The switching device thus begins conducting as indicated by Id, operating, however, in the linear region. However, since Vtrip at this point is still low, the value of Vtt is set by the second voltage division circuit based on Vds, and since Vds is not at a zero level, Vtt does not remain at a low level, preventing the latching state to come into effect. Therefore, as soon as Vconnect-check returns to a low value (i.e. the pulse ends), Vg drops down to a low value, and FET 308 turns off. As Vₚₐₙₑₗ subsequently rises to its normal operating level, with Vds tracking Vₚₐₙₑₗ+Vdiode (the voltage across diode 318), Vtt rises to a level set by the second voltage divider (with resistors 320 and 322) according to Vds, as Vtrip remains low. Thus, even as Vₚₐₙₑₗ is i at its normal operating level, switching device 314 is not conducting, as indicated by Id, and remains turned off, until Vconnect-check is asserted when Vₚₐₙₑₗ is i at a normal operating level, which would turn switching device 314 back on.

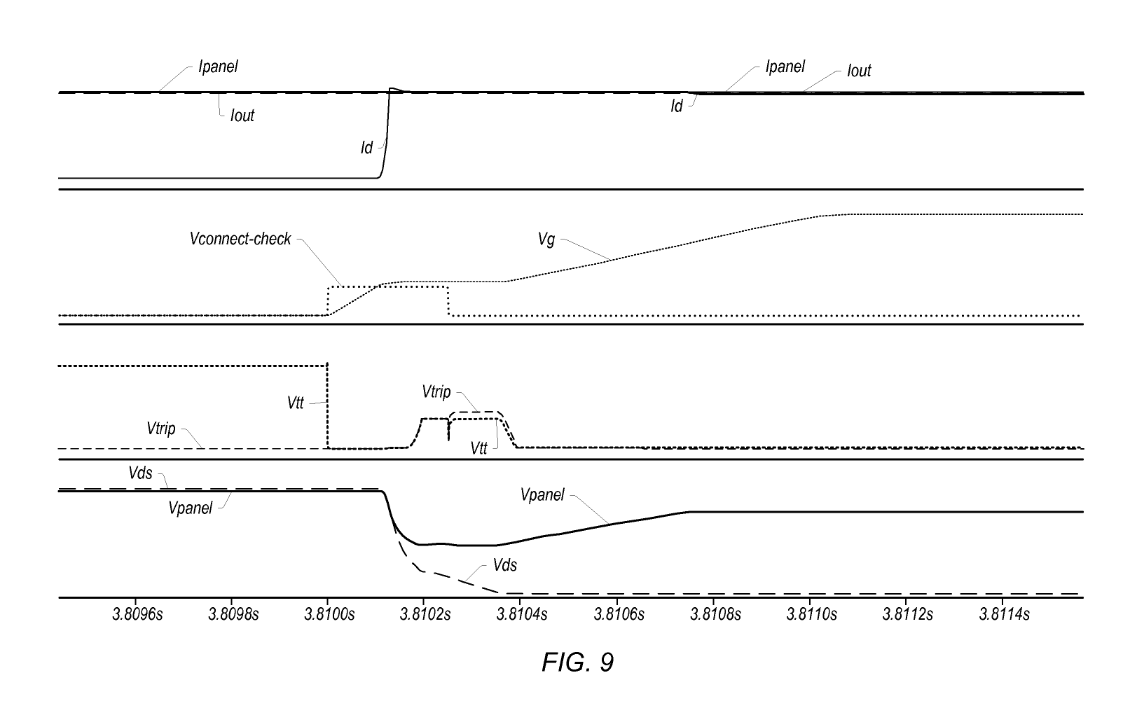

FIG. 9 shows current and voltage diagrams partially illustrating operation of circuit 500, when a connection attempt is made when the panel voltage drops but stays above the panel trip voltage. A seen in FIG. 9, prior to time point 3.8102 sec, Vₚₐₙₑₗ resides at a normal operating level, with Vds tracking Vₚₐₙₑₗ+Vdiode (the voltage across diode 318). Accordingly, Vtrip is low. In this case, power switch 314 is turned off during this period, as indicated by Id, and Vg is low. At around time point 3.8100 sec Vconnect-check is turned on (pulsed) in order to attempt to turn on power switch 314 in case Vₚₐₙₑₗ is i at a proper operating value. Responsive to Vconnect-check being asserted, Vtt is pulled low, which results in Vg beginning to rise to a level commensurate with Vₚₐₙₑₗ. However, during this time, Vₚₐₙₑₗ drops to a value below the expected operating value, while remaining at a voltage level above the panel trip voltage. As Vₚₐₙₑₗ drops, Vds eventually drops to a near-zero level, while power switch 314 is fully conducting as indicated by Id. Accordingly, the value of Vtt does not cause the output of comparator 352 to trip to a low value, and Vg continues to rise, and power switching device 314 remains fully turned on upon release of the connect-check pulse, that is, after Vconnect-check returns to a low value upon expiration of the pulse period.

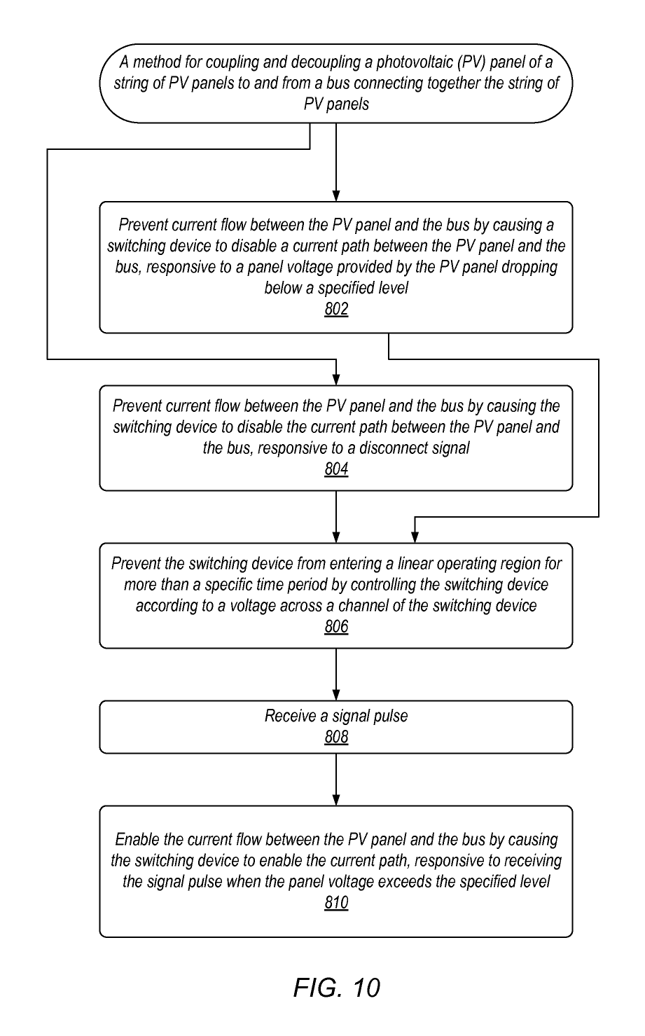

FIG. 10 shows a flowchart of a method for coupling and decoupling a PV panel of a string of PV panels to and from a bus connecting together the string of PV panels, according to various embodiments described above. Current flow between the PV panel and the bus is prevented by causing a switching device to disable a current path between the PV panel and the bus, responsive to a panel voltage provided by the PV panel dropping below a specified level (802). Current flow between the PV panel and the bus is also prevented by causing the switching device to disable the current path between the PV panel and the bus, responsive to a disconnect signal (804). Subsequently, the switching device is prevented from entering a linear operating region for more than a specific time period by controlling the switching device according to a voltage across a channel of the switching device (806). The method may also include receiving a signal pulse (808), and enabling the current flow between the PV panel and the bus by causing the switching device to enable the current path, responsive to receiving the signal pulse when the panel voltage exceeds the specified level (810). In various embodiments, the current path includes the switching device, which may be a power MOSFET. Causing the switching device to disable the current path is achieved by forcing the switching device into an off state, with the switching device prevented from entering the linear operating region by controlling the switching device according also to the panel voltage.

Numerous variations and modifications will become apparent to those skilled in the art once the above disclosure is fully appreciated. It should be noted that the section headings used herein are for organizational purposes only, and are not meant to limit the descriptions provided herein. Numerical values throughout have been provided as examples, and are not meant to limit the descriptions provided herein. Various terms or designations for circuits/components and signals/voltages/currents as they appear herein, for example in such expressions as “switching circuit”, “detection circuit”, “data signal”, “control signal”, “reference voltage”, “control voltage”, etc. are merely names or identifiers used to distinguish among the different circuits/components and/or between different signals, and these terms are not intended to connote any specific meaning, unless specifically noted otherwise.

We claim:

1. A module for engaging and disengaging a photovoltaic (PV) panel configured in a string of PV panels, the module comprising:
a first circuit configured to detect when a panel voltage provided by the PV panel drops below a specified level; and
a second circuit comprising a power switching device configured to:
controllably engage the PV panel to provide power to the string of PV panels; and
controllably disengage the PV panel to stop the PV panel from providing power to the string of PV panels;
wherein the second circuit is configured to:
cause the power switching device to disengage the PV panel from the string of PV panels responsive to the first circuit detecting that the panel voltage has dropped below the specified level; and
prevent the power switching device from operating in a linear region for longer than a limited time duration regardless of a level of the panel voltage.

2. The module of claim 1, wherein the second circuit is configured to prevent the power switching device from operating in the linear region by:
allowing the power switching device to remain in an ‘on’ state when engaging the PV panel; and
causing the power switching device to remain in an ‘off state when disengaging the PV panel.

3. The module of claim 1, wherein the power switching device is a power MOSFET.

4. The module of claim 1, wherein the first circuit comprises:
a first comparator having a first input configured to receive a first control voltage derived from the panel voltage, and further having a second input configured to receive a first reference voltage;
wherein an output of the first comparator is configured to indicate when the panel voltage drops below the specified level by changing states when a level of the first control voltage drops below a level of the first reference voltage.

5. The module of claim 4, wherein the second circuit further comprises:
a second comparator having a first input configured to receive a second control voltage derived from a voltage at the output of the first comparator, and further having a second input configured to receive a second reference voltage;
wherein an output of the second comparator is configured to cause the power switching device to disengage the PV panel from the string of PV panels by changing states when a level of the second control voltage rises above a level of the second reference voltage.

6. The module of claim 5, wherein the first comparator and the second comparator are powered by a supply voltage having a lower value than a minimum voltage required to turn on the power switching device.

7. The module of claim 5, wherein the second circuit further comprises:
a divider circuit configured to sense a voltage across two channel terminals of the power switching device;
wherein the second control voltage is further derived from the voltage sensed across the two channel terminals of the power switching device; and
wherein the divider circuit is configured to cause the power switching device to keep the PV panel disengaged from the string of PV panels by holding the level of the second control voltage above the level of the second reference voltage responsive to the power switching device disengaging the PV panel from the string of PV panels.

8. A circuit for coupling and decoupling a photovoltaic (PV) panel to and from a bus connecting together a string of PV panels including the PV panel, the circuit comprising:
a detection circuit configured to detect when a panel voltage provided by the PV panel drops below a specified level; and
a latching-switching circuit comprising a power switching device configured to:
controllably establish, between the PV panel and the bus, a current path that includes the power switching device; and
controllably disable the current path;
wherein the latching-switching circuit is configured to:
cause the power switching device to disable the current path responsive to the detection circuit detecting that the panel voltage has dropped below the specified level; and
prevent the power switching device from operating in a linear region for longer than a limited time duration regardless of a level of the panel voltage.

9. The circuit of claim 8, wherein the latching-switching circuit is configured to prevent the power switching device from operating in the linear region by:
allowing the power switching device to remain turned on when the panel voltage is not below the specified level; and
keeping the power switching device turned off when the panel voltage is below the specified level.

10. The circuit of claim 8, wherein the power switching device is a power MOSFET.

11. The circuit of claim 8, wherein the detection circuit comprises:
a first device having an input configured to receive a first control voltage derived from the panel voltage, and further having an output configured to change states when a level of the first control voltage drops below a first reference voltage level, indicative that the panel voltage has dropped below the specified level.

12. The circuit of claim 11, further comprising a first voltage divider circuit configured to generate the first control voltage by dividing down the panel voltage.

13. The circuit of claim 11, wherein the latching-switching circuit further comprises:
a second device having an input configured to receive a second control voltage derived from a voltage developed at the output of the first device, and further having an output configured to turn off the power switching device by changing states responsive to a level of the second control voltage rising above a second reference voltage level.

14. The circuit of claim 13, wherein the first device and the second device are configured to receive a supply voltage having a lower value than a minimum voltage required to turn on the power switching device.

15. The circuit of claim 5, wherein the latching-switching circuit further comprises:
a divider circuit configured to sense a voltage across two channel terminals of the power switching device;
wherein the second control voltage is further derived from the voltage sensed across the two channel terminals of the power switching device; and
wherein the divider circuit is configured to cause the power switching device to prevent re-establishing the current path by holding the level of the second control voltage above the second reference voltage level responsive to the power switching device disabling the current path.

16. The circuit of claim 13, further comprising:
a transistor device having a built-in body-diode from a first channel terminal to a second channel terminal of the transistor device, wherein the first channel terminal is coupled to the output of the first device and the second channel terminal is coupled to the input of the second device;
wherein a voltage at the output of the first device rising to a level commensurate with a supply voltage powering the first device and the second device causes the body-diode of the transistor device to conduct, raising the second control voltage to a level approaching a specified value lower than the supply voltage.

17. An interface module comprising:
a pair of input terminals configured to couple to a photovoltaic (PV) panel;
a pair of output terminals configured to couple to a bus connecting together a plurality of PV panels in series, wherein a first input terminal of the pair of input terminals and a first output terminal of the pair of output terminals are connected to a common node, wherein a voltage level at the common node is a panel voltage provided by the PV panel;
a switching device having a channel coupled between a second input terminal of the pair of input terminals and a second output terminal of the pair of output terminals; and
control circuitry configured to:
prevent current flow between the second input terminal and the second output terminal by causing the switching device to disable a current path between the second input terminal and the second output terminal, responsive to the panel voltage dropping below a specified level; and
prevent the switching device from entering a linear operating region for more than a specific time period regardless of a value of the panel voltage.

18. The interface module of claim 17, wherein the control circuitry comprises:
a detection circuit coupled across the first input terminal and the second input terminal, wherein the detection circuit has an output, and wherein the detection circuit is configured to change a state of its output responsive to the panel voltage dropping below the specified level;
wherein the switching device is configured to disable the current path responsive to the detection circuit changing the state of its output in response to the panel voltage dropping below the specified level.

19. The interface module of claim 18, wherein the control circuitry further comprises:
a latching circuit coupled to the detection circuit, the second input terminal, the first output terminal, and the switching device, and configured to hold the switching device in an off state while the panel voltage is below the specified level.

20. The interface module of claim 19, wherein the latching circuit comprises a sense circuit configured to sense a voltage across the channel of the switching device;
wherein the latching circuit is configured to control the switching device responsive to the sensed voltage.

21. The interface module of claim 20, wherein the sense circuit comprises a voltage divider circuit coupled across the channel of the switching device;
wherein the latching circuit is configured to control the switching device according to an output of the voltage divider circuit.

22. A method for coupling and decoupling a photovoltaic (PV) panel of a string of PV panels to and from a bus connecting together the string of PV panels, the method comprising:
preventing current flow between the PV panel and the bus by causing a switching device to disable a current path between the PV panel and the bus, responsive to a panel voltage provided by the PV panel dropping below a specified level; and
preventing the switching device from entering a linear operating region for more than a specific time period by controlling the switching device according to a voltage across a channel of the switching device.

23. The method of claim 22, wherein the current path includes the switching device.

24. The method of claim 22, wherein the switching device is a power MOSFET.

25. The method of claim 22, wherein said causing the switching device to disable the current path comprises forcing the switching device into an off state.

26. The method of claim 22, wherein said preventing the switching device from entering the linear operating region further comprises controlling the switching device according also to the panel voltage.

27. The method of claim 22, further comprising:
preventing current flow between the PV panel and the bus by causing the switching device to disable the current path between the PV panel and the bus, responsive to a disconnect signal.

28. The method of claim 22, further comprising:
receiving a signal pulse; and
enabling the current flow between the PV panel and the bus by causing the switching device to enable the current path, responsive to said receiving the signal pulse when the panel voltage exceeds the specified level.

29. A PV (photovoltaic) array, comprising:
a plurality of PV power panels, wherein each respective PV panel of the plurality of PV panels provides a respective output current and a respective output voltage; and
a plurality of interface units, wherein each respective interface unit of the plurality of interface units is coupled between a corresponding respective PV panel of the plurality of PV panels and a voltage bus;
wherein each respective interface unit is configured to:
establish a current path through a switching device between the voltage bus and the respective PV panel corresponding to the respective interface unit; and
prevent the switching device from operating in a linear operating region long enough for energy dissipated by the interface unit to reach a specified level.

30. The PV array of claim 29, wherein each respective interface unit is further configured to:
prevent current flow through the switching device between the voltage bus and the respective PV panel corresponding to the respective interface unit, responsive to the respective output voltage provided by the PV panel corresponding to the respective interface unit dropping below a specified level.

31. The PV array of claim 29, wherein each interface unit is further configured to:
prevent the switching device from operating in the linear operating region long enough for the energy dissipated by the interface unit to reach the specified level by controlling the switching device according to a voltage across a channel of the switching device.
